(19) United States
(12) Patent Application Publication
(10) Pub. No.: US 2013/0012850 A1
(43) Pub. Date: Jan. 10, 2013

(54) KNEE PAIN TREATMENT

(75) Inventors: Oliver HUTCHEON, Guernsey (GB); Ranjan Vhadra, Guernsey (GB)

(73) Assignee: MEDICAL LIGHT ENGINEERING LTD., Guernsey (GB)

(21) Appl. No.: 13/543,559

(22) Filed: Jul. 6, 2012

(30) Foreign Application Priority Data
Jul. 6, 2011 (GB) 1111552.4

(51) Int. Cl. A61H 1/00

(52) U.S. Cl. 601/46

(57) ABSTRACT

A method of treating knee pain comprising applying directly to the knee a vibrating device.

This invention relates to the treatment of knee pain, in particular treatment of arthritis or oesteoarthritis of the knee, patella tendonitis, chrondromalacia, Osgood-Schlatter disease or gout in humans. The invention further relates to the use of a device suitable for the treatment of these conditions.

### BACKGROUND

Numerous people throughout the globe are affected by knee pain. The nerves which provide sensation to the knee originate in the lower back. The same nerves extend to the hips, legs and ankles. Knee pain may therefore originate directly from the knee or may be the result of a condition located in the one or more of these other regions of the body. Typically, knee pain can be classified as acute or chronic. The former is usually associated with an acute injury or infection, whereas the latter is more often the result of injuries or inflammation. Common causes of knee pain associated with inflammation include arthritis, oesteoarthritis, patella tendonitis, chrondromalacia, Osgood-Schlatter disease or gout.

Various treatments for knee pain are proposed in the art and these vary depending on the origin of the pain. Applying heat and ice in combination is a common treatment as ice controls swelling and heat heals and promotes blood flow and also relieves tightness and pain. NSAIDS may also be administered to reduce inflammation.

Physiotherapy is also widely used to treat knee pain. Manual physiotherapy may be an important part of the treatment and can take the form of joint mobilisations/manipulations and/or extensor muscle tissue mobilisations. The patient may also be required to enter into a regime of exercise to accelerate recovery. More sophisticated treatments include ultrasound and laser treatment both of which can be used to reduce inflammation and promote collagen production although the current evidence for their efficacy is inconclusive. Steroid injections are also used to treat knee pain and knee braces may be beneficial where the patient still maintains a good level of mobility. As a final resort, surgery can be employed.

There still remains, however, the need to devise further treatments for this common affliction, in particular, simple and economic treatments which can be carried out by the patient without a skilled medical practitioner being present.

The present inventor has now realised that a highly effective treatment for knee pain, in particular knee pain resulting from arthritis, osteoarthritis, patella tendonitis, chrondromalacia, Osgood-Schlatter disease or gout, is mild vibration therapy. The use of vibration therapy has been surprisingly found to have potential in reduction of pain and acceleration of recovery from knee pain, in particular accelerated healing of both bone and tendon. Most usefully, vibration therapy can be applied at home by the patient without the presence of a medical practitioner. The vast majority of the treatments above require an expert physiotherapist, sonographer or doctor to administer the injection, carry out massage, apply ultrasound and so on. Vibration can be applied to the afflicted area by the patient simply by applying a vibrating device to the area of the body in question. In this way, the treatment can be carried out almost anywhere, at any time and at any frequency. This treatment is thus even more useful (and effective) than ice and heat therapy as it does not require a source of ice and a source of heat. The user need carry with him only a small vibrating device, perhaps no larger than a mobile phone, which he can attach to his knee to carry out treatment anywhere he may be.

### SUMMARY OF INVENTION

Thus, viewed from one aspect the invention provides a method of treating knee pain comprising applying directly to the knee a vibrating device, in particular one as described herein.

Viewed from another aspect the invention provides a device for the treatment of knee pain comprising;

a housing;

a vibration generating device within the housing;

a vibration transmitting member projecting from the housing; and

a strap on the housing for holding the device against a patient's knee,

wherein the vibration transmitting member projects from the housing at a position which is longitudinally spaced from the strap, so that the vibration transmitting member can supply vibrations to a patient's knee when it is strapped to the patient's leg.

Viewed from another aspect the invention provides a device for use in the treatment of knee pain comprising;

a housing;

a vibration generating device within the housing;

a vibration transmitting member projecting from the housing; and

a strap on the housing for holding the device against a patient's knee,

wherein the vibration transmitting member projects from the housing at a position which is longitudinally spaced from the strap, so that the vibration transmitting member can supply vibrations to a patient's knee when it is strapped to the patient's leg.

Viewed from another aspect the invention provides a method of treating knee pain associated with arthritis or oesteoarthritis of the knee, patella tendonitis, chrondromalacia, Osgood-Schlatter disease or gout comprising applying directly to the knee a vibrating device, in particular one as described herein.

### DETAILED DESCRIPTION

The present invention requires the use of a vibrating device to generate the vibrations required for treatment of knee pain. Thus, the necessary vibrations are generated at low frequency and mechanically as opposed to electromagnetically (e.g. using a laser) or by shockwave (e.g. using ultrasound). Conveniently, the vibration will be generated by a vibrating device as described herein. The use of low frequency mechanically generated vibration is important as the use of a simple mechanical vibrating device gives rise to a different type of vibration than shockwave or light therapy and is a much cheaper and more readily applied form of vibration therapy.

Low frequency vibrations generated mechanically and applied locally to the injured knee stimulate the formation of new blood vessels (angiogenesis) thereby increasing the blood supply to the afflicted knee and associated tendons, muscles and joints and thereby accelerating recovery. Thus, to treat knee pain, the knee is contacted with the vibrating device which may be held against the knee by any convenient means. In this way, vibrations are applied directly to the injured knee, in particular the injured tendon and associated muscle. Preferably, the device should contact the skin directly rather than through clothing or the like.

The vibrating device needs to be placed against the knee where the affliction is located. The patient can be provided with clear instruction on where to place the device through a user guide or by a doctor, physiotherapist and so on. It is essential therefore that the vibrating member of the device of the invention contacts the knee. Vibrating the whole leg or using a vibrating platform is not considered here. The use of such devices is cumbersome and expensive. The benefit of the device of the invention include that it is portable and usable anywhere, anytime.

The device can be applied to the knee by any convenient means. Thus, in one embodiment a patient may simply hold the device against his knee. Preferably however, the device will be adapted to attach to the knee in some fashion. This may be achieved using a strap which can be put around the knee/leg and device and tightened to ensure that the device does not fall and that the device contacts the knee with sufficient pressure that the vibrations are transmitted. Alternatively it may be possible to attach the device using some form of adhesive or the device could be held in place under tight fitting clothing or under a knee support, e.g. a neoprene type support often worn by athletes. The skilled man can devise many ways of attaching the device to the body so that it is arranged to contact the appropriate part of the knee. The use of a particular strap arrangement described below is especially preferred.

The vibrating device produces mild vibrations, similar to those produced by a vibrating mobile telephone. It is important therefore that the device does not subject the knee to strong high frequency vibrations as such vibrations could actually be damaging and painful. The skilled man will be readily able to devise a device that produces an acceptable level of vibration. For example, devices powered by less than 3 watts, preferably less than 1 watt may be suitable here. As noted above, vibration levels may be similar to those achieved by mobile telephones or by a massage device.

Thus, the frequency of vibration may be 100 to 300 oscillations per second, e.g. 150 oscillations per second, i.e. around 100 to 300 Hz. It is stressed that the vibrating device of the invention operates at low frequency, i.e. less than 1 kHz and does not therefore encompass ultrasonic treatment and the like.

The duration of each vibration therapy treatment can vary across wide limits but typically sessions of 5 to 20 minutes e.g. 7 to 15 minutes, especially about 10 minutes are appropriate. Some patients may choose to leave the device vibrating on the body throughout the day to maximise recovery potential.

Therapy sessions can be repeated many times daily if required. Conveniently, the vibration therapy will be employed 2 to 5, e.g. 3 times a day.

The skilled man can devise a wide variety of vibrating devices suitable for use in the invention but it is stressed that the vibrations must be low frequency mechanical vibrations generated by some form of oscillating device as opposed to sound wave or electromagnetic wave induced vibration. Vibration itself can be achieved using known technology, e.g. that used in mobile phones. For example, a motor can drive a gear on which is set a weight mounted off-centre on the gear. When the motor spins the gear/weight combination the off-centre mounting causes a vibration. In a preferred embodiment, the vibrating device of use in the invention comprises such a gear/weight combination.

The whole device can vibrate if desired although preferably, vibration is primarily confined to a particular part of the device which can be arranged to contact the knee in the position where treatment is desired. In a preferred embodiment, the device comprises a vibrating member which is movable with the housing of the device and it is only this part of the device which vibrates on activation. Ideally the vibrating means, e.g. gear/weight combination, contacts the vibrating member which thus vibrates independently from the rest of the device and thus provides a specific area of vibration which can be applied to the knee.

The vibrating member preferably projects from the outer surface of the housing providing a vibrating surface which can be arranged to contact the knee. The member which vibrates can be any shape but a circular disk shaped projection is preferred as this is ideally shaped to contain the gear/weight combination. In particular, a vibration nozzle might be used.

The housing of the device may have a planar surface adapted to contact the skin of the knee/leg or may be moulded to mirror the contours on the knee/leg. The housing is preferably formed from plastic or rubber type material. Moulding can therefore can be readily achieved using well known plastic moulding technology.

The size of the device could be varied to take account of different leg sizes although a single sized device is suitable for knee pain treatment in all patients. Typically, the device may be between 5 and 10 cm in length and is thus readily portable. The projecting vibrating member may be of the order of 1 to 2 cm in length (e.g. in diameter). It may project from the housing by the order of 0.5 to 2 mm.

The device is preferably battery powered so that no mains connection is needed although, if required, a device which can be run from mains electricity or run on both battery and mains power can be devised. Battery power is preferred and the device may use a rechargeable or non rechargeable battery. Most conveniently, the device can be run on AA or AAA batteries.

The device may be programmable so that the user may set a fixed period during which vibration will occur. Thus, the device may contain a printed circuit board connected to the vibrating means which relays information on the duration of treatment inputted into the device by the user. The device may also include a screen displaying, for instance, the set vibration time and elapsed time or time to end of the treatment period once the treatment begins. A simpler device may have only an activating button which causes vibration for a predetermined period, e.g. 10 minutes.

Preferably, the vibrating member is in contact with a vibrating means arranged to cause vibration of the member.

Viewed from another aspect the invention describes a kit comprising a vibrating device as hereinbefore defined and instructions for the use thereof in the treatment of knee pain.

Viewed from another aspect therefore the invention provides a device for the treatment of knee pain, said device comprising;

a housing;

a vibration generating device within the housing;

a vibration transmitting member projecting from the housing; and

a strap on the housing for holding the device against a patient's leg,

wherein the vibration transmitting member projects from the housing at a position which is spaced from the strap, so that the vibration transmitting member can supply vibrations to the patient's knee when it is strapped to the patient's leg.

There may be for example, a gap of at least 1 cm, e.g. at least 2 cm, preferably 3 to 10 cm, such as 3 to 5 cm between the edge of the strap nearest the projection and the centre of the projection itself. The strap is preferably positioned therefore up or most preferably down the leg from the knee and the vibration transmitting member is spaced from the strap longitudinally up or down the leg. The strap preferably passes all the way around the leg of the patient. In use therefore it is preferred that the strap does not hinder movement of the knee. The strap is preferably positioned below the knee. It is also preferred if the strap does not cover the actuating button.

In a further preferred embodiment, at least a part of the device is sandwiched between two layers of the strap. In particular, the vibration transmitting member projects from the housing at a position which is spaced from the strap, but the other part of the housing is sandwiched between two layers of the strap. The only part of the device touching the skin is therefore may be the vibration transmitting member. The main body of the device may therefore be held by two layers is strap. In use, one passes underneath the device and the other over the top of the device to secure it rigidly to the leg. This makes the device more comfortable to wear and ensures that the device is held in place during use and perhaps during movement of the knee in use.

Moreover, by sandwiching the device between two layers of strap, the user is able to vary the compression of the device onto the knee.

Ideally the device operates whether the knee is bent or straight.

A further device of the invention is therefore a device for the treatment of knee pain comprising;

a housing;

a vibration generating device within the housing;

a vibration transmitting member projecting from the housing; and

a strap on the housing for holding the vibration transmitting member against a patient's knee,

wherein the vibration transmitting member projects from the housing at a position which is longitudinally spaced from the strap, so that the vibration transmitting member can supply vibrations to a patient's knee when it is strapped to the patient's leg; and wherein in use said housing is sandwiched between two layers of strap.

A highly preferred device is described in FIGS. 1 and 2.

In use, the device may be strapped onto the leg of the patient. The device housing may therefore be provided with a strap holder which enables a strap, e.g. a Velcro strap, to pass through the device housing and around the patient's leg. The device is placed against the skin near and the device secured in place by tightening the strap. The device is activated by depression of the actuating button and deactivated by pressing the button once more.

The device as hereinbefore described in particularly useful for the treatment of knee pain originating from arthritis or oesteoarthritis, patella tendonitis, chrondromalacia, Osgood-Schlatter disease or gout. Viewed from another aspect, the invention describes the use of a device as hereinbefore described for the treatment of arthritis or oesteoarthritis of the knee, patella tendonitis, chrondromalacia, Osgood-Schlatter disease or gout.

The invention will now be described in relation to the following non limiting Examples and Figures.

### BRIEF DESCRIPTION OF THE FIGURES

FIG. 1 shows a preferred vibrating device of the invention.

FIG. 2 shows the preferred device of the invention in cross section.

FIGS. 3 and 4 are depictions of a preferred device in use.

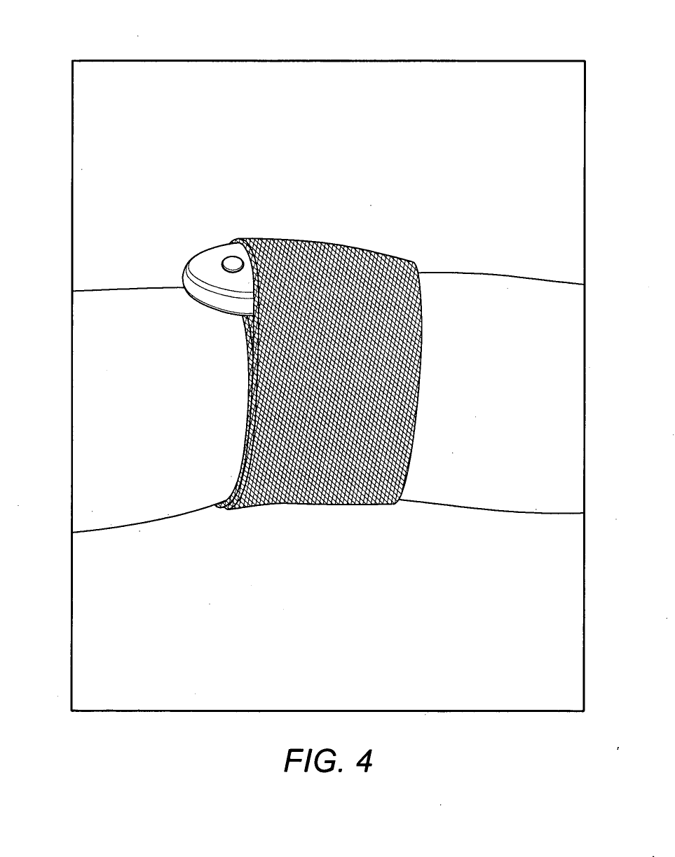

### EXAMPLE 1

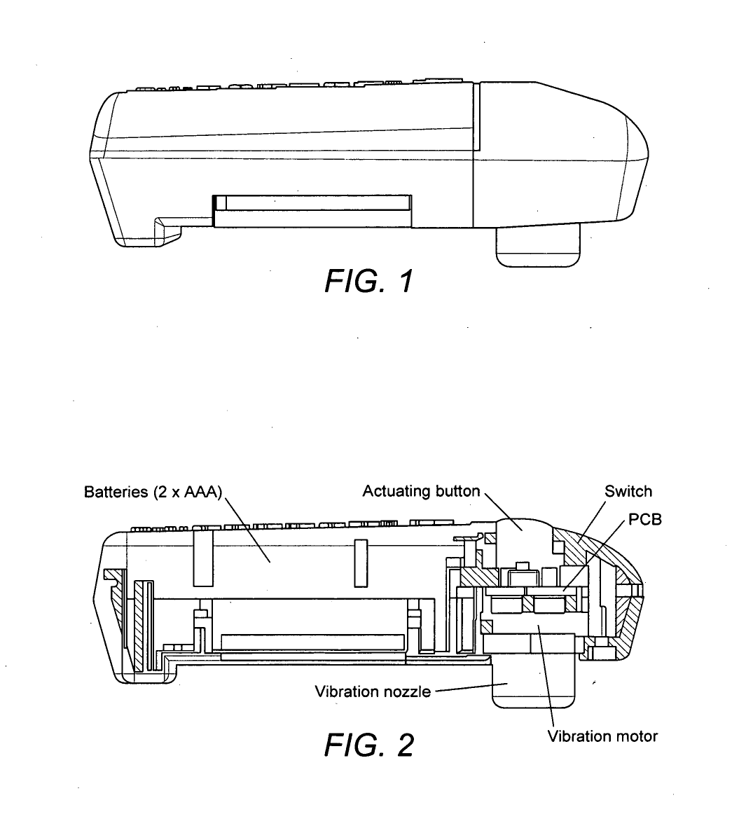

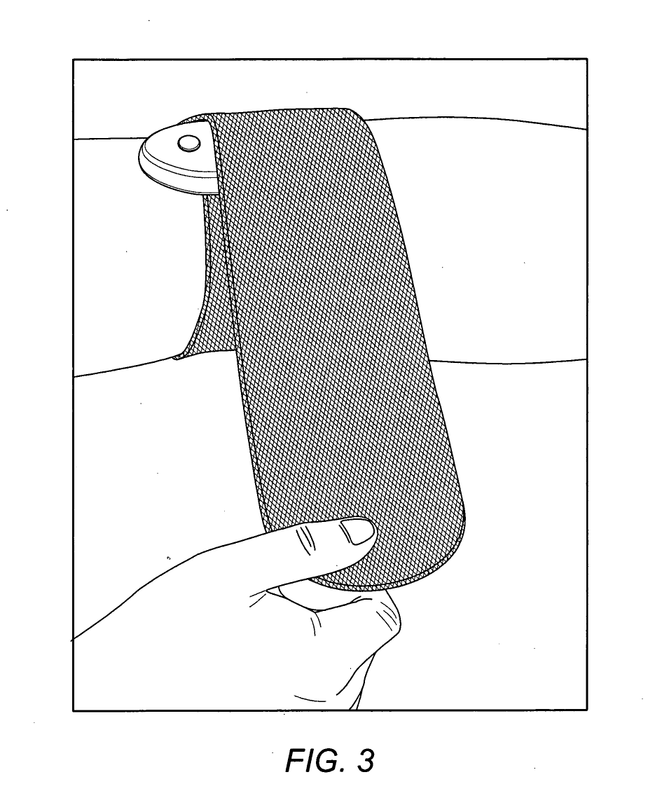

A patient suffering from arthritis of the knee has attached to his knee a device as shown in FIGS. 1 and 2 at night. The vibration therapy reduces the pain of arthritis experienced by the patient and offers an improvement compared to previously used remedies, such as injection.

### EXAMPLE 2

A patient suffering from knee pain who, as a result, experiences instability whilst walking, has attached to his knee a device as shown in FIGS. 1 and 2. The patient has suffered from the pain for a number of years and is now experiencing deterioration of the condition. The vibration therapy reduces the pain experienced by the patient for around 1 hour and improves walking. The device is considered a good alternative to surgery.

### EXAMPLE 3

A patient suffering from osteoarthritis of the knee has attached to his knee a device as shown in FIGS. 1 and 2. The device is used in particular after playing golf. The vibration therapy offered relief by removing the pain and stiffness experienced by the patient.

1. A method of treating knee pain comprising applying directly to the knee a vibrating device.

2. A method as claimed in claim 1 wherein the knee pain is associated with arthritis or oesteoarthritis of the knee, patella tendonitis, chrondromalacia, Osgood-Schlatter disease or gout.

3. A method as claimed in claim 1 wherein said device comprises:
a housing;
a vibration generating device within the housing;
a vibration transmitting member projecting from the housing; and
a strap on the housing for holding the device against a patient's leg,
wherein the vibration transmitting member projects from the housing at a position which is spaced from the strap, so that the vibration transmitting member can supply vibrations to a patient's knee when it is strapped to the patient's leg.

4. A method as claimed in claim 1 wherein said device comprises: a housing;
a vibration generating device within the housing;
a vibration transmitting member projecting from the housing; and
a strap on the housing for holding the vibration transmitting member against a patient's knee,
wherein the vibration transmitting member projects from the housing at a position which is longitudinally spaced from the strap, so that the vibration transmitting member can supply vibrations to a patient's knee when it is strapped to the patient's leg; and wherein in use said housing is sandwiched between two layers of strap.

5. A vibrating device for the treatment of knee pain, wherein said device comprises:
a housing;
a vibration generating device within the housing;
a vibration transmitting member projecting from the housing; and
a strap on the housing for holding the device against a patient's leg,
wherein the vibration transmitting member projects from the housing at a position which is spaced from the strap, so that the vibration transmitting member can supply vibrations to a patient's knee when it is strapped to the patient's leg.

6. A device for the treatment of knee pain comprising;
a housing;
a vibration generating device within the housing;
a vibration transmitting member projecting from the housing; and
a strap on the housing for holding the vibration transmitting member against a patient's knee,
wherein the vibration transmitting member projects from the housing at a position which is longitudinally spaced from the strap, so that the vibration transmitting member can supply vibrations to a patient's knee when it is strapped to the patient's leg; and wherein in use said housing is sandwiched between two layers of strap.

7. A kit comprising a vibrating device as described in claim 4 and instructions for the use thereof in the treatment of knee pain.
